(19) United States
(12) Patent Application Publication
(10) Pub. No.: US 2014/0152538 A1
(43) Pub. Date: Jun. 5, 2014

(54) View Detection Based Device Operation

(71) Applicant: PLANTRONICS, INC., Santa Cruz, CA (US)

(72) Inventors: Soohyun Ham, San Francisco, CA (US); Douglas K. Rosener, Santa Cruz, CA (US)

(73) Assignee: Plantronics, Inc., Santa Cruz, CA (US)

(21) Appl. No.: 13/690,589

(22) Filed: Nov. 30, 2012

(51) Int. Cl. G06F 3/01

(52) U.S. Cl. CPC G06F 3/01
USPC 345/156

(57) ABSTRACT

Methods and apparatuses for peripheral device operation are disclosed. In one example, a user viewing direction is detected corresponding to the user viewing a first display or a second display. Responsive to the user viewing direction, a peripheral device is operated with a first device or a second device.

### BACKGROUND OF THE INVENTION

In the modern work and home environment, people typically have multiple computing devices. For example, most people today have a desktop computer, notebook computer, tablet computer, and a smart phone. Since each of these devices may offer different functionality, users often wish to have multiple devices available for use on their desktop. Users also often wish to switch use between devices, or operate multiple devices simultaneously.

For example, many office workers use two displays with their notebook computer along with a mobile device like a smart phone or a tablet when they are working at their desk. In advanced usage scenarios, a single user can have several computing devices (e.g., a desktop PC, notebook computer, and a tablet computer), two monitors, two keyboards, and/or two mice on a single desk, all of which are simultaneously in operation. In another example, each screen/computing-device may have a different audio communication link (e.g. Lync) via a headset. In a further example, a single screen may have multiple audio communication links.

The use of multiple computing devices on a desktop poses several problems for users. Where each device has its own physical keyboard and mouse, the user must switch keyboards and mice in order to use a different device. This may require that the user reposition the devices on the desktop, such as moving a notebook computer in front of the user and moving away a keyboard. In addition, the user may prefer to use an external keyboard instead of the notebook keyboard, which may have fewer keys and may be less ergonomic. Some devices, such as tablet computers or smart phones, may not have their own external keyboard, requiring yet another keyboard on the desktop in a case where the user wishes to use an additional keyboard for their tablet while the tablet is docked vertically. The presence of multiple keyboards, mice, or other peripheral devices creates clutter on the desktop, consumes valuable desktop real estate, and is visually unappealing. There may also be confusion as to which peripheral operates with which device. In the case of multiple audio communication links via headsets, the user is required to click on the application to switch the link.

As a result, improved methods and systems for operating peripheral devices with computing devices are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for operating an input/output device in one example.

FIG. 2 illustrates a system for operating an input/output device in a further example.

FIG. 3 illustrates an example implementation of the system shown in FIG. 2.

FIG. 4 illustrates a system for operating an input/output device in a further example.

FIG. 5 is a flow diagram illustrating operation of an input/output device in one example.

FIG. 6 is a flow diagram illustrating operation of an input/output device in one example.

### DESCRIPTION OF SPECIFIC EMBODIMENTS

Methods and apparatuses for view detection based device operation are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

In one example, a method for operating a peripheral device includes detecting a user viewing direction (also referred to as gaze direction or facing) corresponding to a first display associated with a first device or a second display associated with a second device, and responsive to the user viewing direction, operating a peripheral device with the first device or the second device. In one example, the peripheral device is an input/output device.

In one example, a computer readable storage memory stores instructions that when executed by a computer cause the computer to perform a method for operating a device. The method includes receiving a data processable to determine a user viewing direction, and processing the data to determine whether the user is viewing a display. Responsive to a determination the user is viewing the display, a device associated with the display is operated with an input/output device.

In one example, a device includes a processor, a wireless transceiver operable to form a wireless communications link with an input/output device, and a display. The device includes a memory storing an application executable by the processor, the application configured to process a data to determine whether a user is viewing the display, where the application is further configured to operate the device with the input/output device if the user is viewing the display.

In one example, a device includes a processor, a wireless transceiver operable to form a wireless communications link with an input/output device, a camera to output a camera data, and a display. The device includes a memory storing an application executable by the processor, the application configured to process the camera data to determine whether a user is viewing the display, where the application is further configured to operate the device with the input/output device if the user is viewing the display.

In one example, a system includes a head worn device and a device. The head worn device includes a sensor to output orientation data. The device includes a processor, and a memory storing an application executable by the processor. The application is configured to process the orientation data to determine whether the user is viewing a display, and the application is further configured to operate a device associated with the display with an input/output device if the user is viewing the display.

In one embodiment, a computer peripheral device (e.g., a wireless keyboard and/or mouse, or headset) is Bluetooth paired to multiple devices and monitors so a user can switch the usage (e.g., between PCs, MACs, tablets, smart phones, applications or programs) back and forth seamlessly by using head or eye tracking enabled devices or software. When facing or looking at a specific screen, the tracking device or software senses the user head or eye direction and switches connectivity of the keyboard and/or mouse or headset to the device or program/application the user is facing or looking. In this manner, a single keyboard or mouse, or headset can be used with multiple computing devices, switching its connection seamlessly.

In further examples, peripheral devices in addition to keyboard and mouse input are utilized for gaze-based input processing. For example, the audio into a headset can be switched depending on which display is being looked at. In general, any computing device participating in the system can start or stop any operations based on whether the user is looking or not looking at the associated screen. In one example, a projection on the wall of a computing devices output can also be used as criteria for where the user is looking.

In one example, a head mounted-wearable device like a headset, headphones or glasses follows a user's head directional movement and sends the information to software that switches the connectivity of a wireless keyboard or a mouse. In one implementation, the user head orientation data, keyboard input date, and mouse input data is streamed via one of the computing devices to a server. For example, the streaming could be performed using Web Sockets, and the data could consist of key presses, mouse movements, and head orientation expressed as angles or quaternions (numerical 4-tuples indicating absolute or relative orientation). The other computing devices could be clients to the server and subscribe to the stream of angles/quaternions. Quaternions are more useful in those cases where the sensors can detect/report three-dimensional orientations as opposed to planar (compass heading only).

In one example, each display screen available is assigned a number (e.g., 1, 2 or 3). The user calibrates the system by selecting one of the displays, looking at each of the four edges of the screen while clicking a button on the computing device being calibrated or issuing a voice command to “calibrate”. When done, the local electronic device would store the quaternions for each edge. The incoming quaternion stream is then used to compare to the edges and determine when the user is looking at the screen. This may be done by reducing the incoming quaternions to Euler angles and verifying that the vertical and horizontal “look angles” match the range of the calibrated edges.

All computing devices constantly examine the quaternion stream. When the user looks at a given display for a computing device, the electronic device recognizes the user is looking at it. It then pays attention to the keyboard and mouse stream and uses and displays it appropriately. The mouse movement is typically differential, so that a given screen would just start picking up mouse movement from where it left off with no calibration needed.

In one example, a camera is used to detect the user viewing direction. In one embodiment, a video-based eye tracker is used. The built in camera of the computing device detects the user eye movements or eye positions and sends a signal to the software or application that switches the connectivity of a wireless keyboard or a mouse, depending on which screen a user is looking at. In one embodiment, each computing device screen has a camera mounted on it. Each camera executes a detector algorithm to determine when the user is looking at the screen. This can be done by any of a variety of methods. For example, eye tracking techniques may be utilized. In a further example, the camera captures the user profile and the output is processed to analyze the orientation of the user head and face, including eye position and direction, to determine if the user is viewing the display.

In a further example, a calibration process is utilized so that the data from each device camera is used to determine whether the user is viewing a first display or a second display. During calibration, the user views the first display and the first camera output is captured and stored for processing and later comparison. The user then views the second display and the second camera output is captured and stored for processing and later comparison. In operation, the user profile is captured by a camera and compared to the previously stored profile to determine which display is being viewed.

In a further example, a head-mounted camera focused on the eye can provide data to detect and model the position of the irises and/or pupils within the eye. This coupled with head orientation (either from a head-mounted system or fixed camera system) can be used to directly compute user gaze angle.

In a further example, a head mounted device can have an infrared diode source and the screen/devices can have an infrared detector. When the user looks at the screen/device, the detector receives the IR radiation which can be used as an indicator that the user is looking at that screen. These IR sources and detectors have angular cones of operation allowing a range of angles where the user can be considered to be viewing the screen.

In one example, the keyboard and mouse information is streamed as outlined above in the head-mounted embodiment. When an algorithm on a computer device detects gaze is toward its screen, it would then pay attention to the keyboard and mouse stream. In yet another example, one camera is used to monitor a head angle on a single computing device for all screens used and stream look angle, again operating as in the head mounted version.

Advantageously, a user can use, for example, a single keyboard and/or a single mouse for multiple combinations of computers or mobile devices that are connected wirelessly (e.g., using Bluetooth) and switch the device back and forth seamlessly. Since the switching is based on which display the user is viewing, operation of the peripheral devices seamlessly follows the user's natural behavior. The user may be required to view a display a certain amount of time (e.g., approximately 500 ms) before switching to avoid nuisance switching.

In one example mode of operation, a mobile device is operable as the head-tracking receiver/event-generator (and optionally keyboard and mouse events). The mobile device sends events to the network to subscribing machines running the associated application to subscribe and remap keyboard and mouse events. In this example, the headset is not required to connect to any of the computers to be controlled. This example optionally allows the user to carry their keyboard and mouse with them without attaching them to the other computers as well.

In one example mode of operation, a user is conducting two simultaneous VOIP conversations, each on a different display screen. When the user looks at one screen, bidirectional audio is switched to that screen. When the user changes her gaze to the other screen, audio is directed to that corresponding conversation.

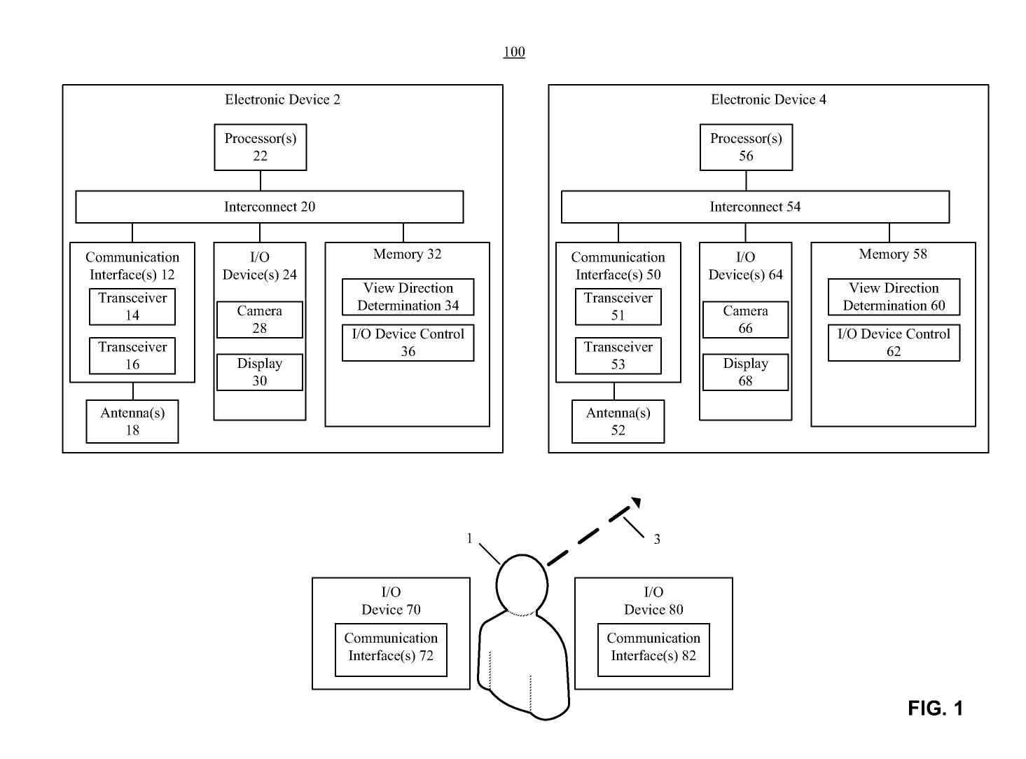

FIG. 1 illustrates a system 100 for operating a peripheral (e.g., input/output) device in one example. System 100 includes an electronic device 2, an electronic device 4, an input/output (I/O) device 70, and an I/O device 80. Electronic device 2 and electronic device 4 may, for example, be computing devices such as a laptop computer, tablet computer, smart phone, or desktop computer.

For example, I/O device 70 and I/O device 80 may be a wireless alphanumeric input device (e.g., a keyboard) and a wireless cursor control device (e.g., a mouse) to provide input to electronic device 2 or electronic device 4. In a further example, I/O device 70 or I/O device 80 may be a wireless head worn device to receive data from electronic device 2 or electronic device 4. I/O device 70 includes communication interface(s) 72 for communication with electronic device 2 and electronic device 4, and I/O device 80 includes communication interface(s) 82 for communication with electronic device 2 and electronic device 4.

Simplified block diagrams of these devices are illustrated. In further examples, the number of electronic devices and displays may vary and the number of I/O devices may vary. For example, there may be more than two electronic devices and there may be only a single I/O device 70. In one example, the electronic device 2 and the electronic device 4 each include a two-way RF communication device having data communication capabilities. The electronic device 2 and electronic device 4 may have the capability to communicate with other computer systems via a local or wide area network. I/O device 70 and I/O device 80 are in proximity to a user 1. As described in the examples below, I/O device 70 and I/O device 80 may operate with electronic device 2 and electronic device 4 over wireless communication links depending upon a viewing direction 3 of a user 1. In a further example, wired links between devices may be used. I/O devices may be wired either simultaneously to multiple devices or wired to a single device with data passed to the other device.

Electronic device 2 includes input/output (I/O) device(s) 24 configured to interface with the user, including a camera 28 and a display 30. Camera 28 is configured to output camera data. I/O device(s) 24 may also include additional input devices, such as a touch screen, etc., and additional output devices. Display 30 may, for example, be a liquid crystal display (LCD) or a projector with an associated projection screen. Camera 28 may be disposed in relation to display 30 such that the user 1 is facing the camera 28 when he or she is facing the display 30. For example, camera 28 is disposed in the center of the top bezel of display 30.

The electronic device 2 includes a processor 22 configured to execute code stored in a memory 32. Processor 22 executes a view direction determination application 34 and an I/O device control application 36 to perform functions described herein. Although shown as separate applications, view direction determination application 34 and I/O device control application 36 may be integrated into a single application.

Utilizing view direction determination application 34, electronic device 2 is operable to process the camera data from camera 28 to determine whether the user 1 is viewing the display 30. Following this determination, electronic device 2 utilizes I/O device control application 36 to operate the electronic device 2 with the I/O device 70 and I/O device 80 if the user is viewing the display 30.

While only a single processor 22 is shown, electronic device 2 may include multiple processors and/or co-processors, or one or more processors having multiple cores. The processor 22 and memory 32 may be provided on a single application-specific integrated circuit, or the processor 22 and the memory 32 may be provided in separate integrated circuits or other circuits configured to provide functionality for executing program instructions and storing program instructions and other data, respectively. Memory 32 also may be used to store temporary variables or other intermediate information during execution of instructions by processor 22.

Memory 32 may include both volatile and non-volatile memory such as random access memory (RAM) and read-only memory (ROM). Data for electronic device 2 may be stored in memory 32, including data utilized by view direction determination application 34. For example, this data may include data output from camera 28.

Electronic device 2 includes communication interface(s) 12, one or more of which may utilize antenna(s) 18. The communications interface(s) 12 may also include other processing means, such as a digital signal processor and local oscillators. Communication interface(s) 12 include a transceiver 14 and a transceiver 16. In one example, communications interface(s) 12 include one or more short-range wireless communications subsystems which provide communication between electronic device 2 and different systems or devices. For example, transceiver 16 may be a short-range wireless communication subsystem operable to communicate with I/O device 70 and I/O device 80 using a personal area network or local area network. The short-range communications subsystem may include an infrared device and associated circuit components for short-range communication, a near field communications (NFC) subsystem, a Bluetooth subsystem including a transceiver, or an IEEE 802.11 (WiFi) subsystem in various non limiting examples. Communication interface(s) 12 are operable to receive data from communication interface(s) 72 at I/O device 70 and communication interface(s) 82 at I/O device 80.

In one example, transceiver 14 is a long range wireless communications subsystem, such as a cellular communications subsystem. Transceiver 14 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol. In one example, a wired 802.3 Ethernet connection is used.

Interconnect 20 may communicate information between the various components of electronic device 2. Instructions may be provided to memory 32 from a storage device, such as a magnetic device, read-only memory, via a remote connection (e.g., over a network via communication interface(s) 12) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Electronic device 2 may include operating system code and specific applications code, which may be stored in non-volatile memory. For example the code may include drivers for the electronic device 2 and code for managing the drivers and a protocol stack for communicating with the communications interface(s) 12 which may include a receiver and a transmitter and is connected to antenna(s) 18. In one example, communication interface(s) 12 provides a wireless interface for communication with electronic device 4.

Electronic device 4 is similar to electronic device 2 and operates in substantially the same way as electronic device 2 described above. Electronic device 4 includes input/output (I/O) device(s) 64 configured to interface with the user, including a camera 66 and a display 68. Camera 66 is configured to output camera data. I/O device(s) 64 may also include additional input devices, such as a touch screen, etc., and additional output devices. Display 68 may, for example, be a liquid crystal display (LCD). Camera 66 may be disposed in relation to display 68 such that the user 1 is facing the camera 66 when he or she is facing the display 68. For example, camera 66 is disposed in the center of the top bezel of display 68.

The electronic device 4 includes a processor 56 configured to execute code stored in a memory 58. Processor 56 executes a view direction determination application 60 and an I/O device control application 62 to perform functions described herein. Although shown as separate applications, view direction determination application 60 and I/O device control application 62 may be integrated into a single application.

Electronic device 4 includes communication interface(s) 50, one or more of which may utilize antenna(s) 52. The communications interface(s) 50 may also include other processing means, such as a digital signal processor and local oscillators. Communication interface(s) 50 include a transceiver 51 and a transceiver 53. Interconnect 54 may communicate information between the various components of electronic device 4.

The block diagrams shown for electronic device 2 and electronic device 4 do not necessarily show how the different component blocks are physically arranged on electronic device 2 or electronic device 4. For example, transceivers 14, 16, 51, and 53 may be separated into transmitters and receivers.

In one usage scenario, user 1 faces either display 30 at electronic device 2 or display 68 at electronic device 4. The user viewing direction 3 is detected by electronic device 2 or electronic device 4 utilizing camera 28 or camera 66, respectively. If electronic device 2 determines that the user 1 is viewing display 30, electronic device 2 is operated with I/O device 70 and I/O device 80. If electronic device 4 determines that the user 1 is viewing display 68, electronic device 4 is operated with I/O device 70 and I/O device 80.

In another usage scenario, user 1 faces either display 30 at electronic device 2 or display 68 at electronic device 4. The user viewing direction 3 is detected by electronic device 2 or electronic device 4 utilizing camera 28 or camera 66, respectively. If electronic device 2 determines that the user 1 is viewing display 30, electronic device 2 is operated with an I/O device(s) 64 located at electronic device 4. If electronic device 4 determines that the user 1 is viewing display 68, electronic device 4 is operated with I/O device(s) 64 located at electronic device 4. This scenario is particularly advantageous where electronic device 2 is a tablet or smartphone device and electronic device 4 is a notebook computer, and the user wishes to utilize the notebook computer keyboard and/or trackpad (i.e., I/O device(s) 64) with the tablet or smartphone if the user is viewing the tablet or smartphone and with the notebook computer if the user is viewing the notebook computer display.

In one example, to operate electronic device 2 with I/O device 70 and I/O device 80, wireless links are formed or activated between electronic device 2 and I/O device 70 and I/O device 80, and input/output data is transferred to and from electronic device 2. Similarly, to operate electronic device 4 with I/O device 70 and I/O device 80, wireless links are formed or activated between electronic device 4 and I/O device 70 and I/O device 80, and input/output data is transferred to and from electronic device 4.

In a further embodiment, data is transferred from I/O device 70 and I/O device 80 to both electronic device 2 and electronic device 4 regardless of whether the user 1 is viewing display 30 or display 68. In this embodiment, if electronic device 2 determines that the user 1 is viewing display 30, to operate electronic device 2 with I/O device 70 and I/O device 80, electronic device 2 acts upon the received input/output data (i.e., as opposed to merely receiving the data and not acting upon the data). Similarly, if electronic device 4 determines that the user 1 is viewing display 68, to operate electronic device 4 with I/O device 70 and I/O device 80, electronic device 4 acts upon the received input/output data.

In one embodiment, electronic device 2, electronic device 4, I/O device 70, and I/O device 80 include Bluetooth communication modules for Bluetooth wireless communications. One or more Bluetooth piconets may be utilized to connect the devices to perform the desired communications. For example, a point-to-multipoint connection is utilized to connect electronic device 2 to I/O device 70 and I/O device 80. Similarly, a point-to-point multipoint connection is utilized to connect electronic device 4 to I/O device 70 and I/O device 80. In one example, active data links between devices are maintained. In a further example, links are connected, switched, or detected on demand.

In a further example, electronic device 2 may have a second display in addition to display 30, where the view direction determination application 34 is configured to determine whether the user is viewing the display 30 or the second display.

For example, a first application window is shown on the display 30 and a second application window is shown on the second display, where the first application window is active and interfaces with the input/output device 70 and/or input/output device 80 if the user is viewing the display 30 and the second application window is active and interfaces with the input/output device 70 and/or input/output device 80 if the user is viewing the second display.

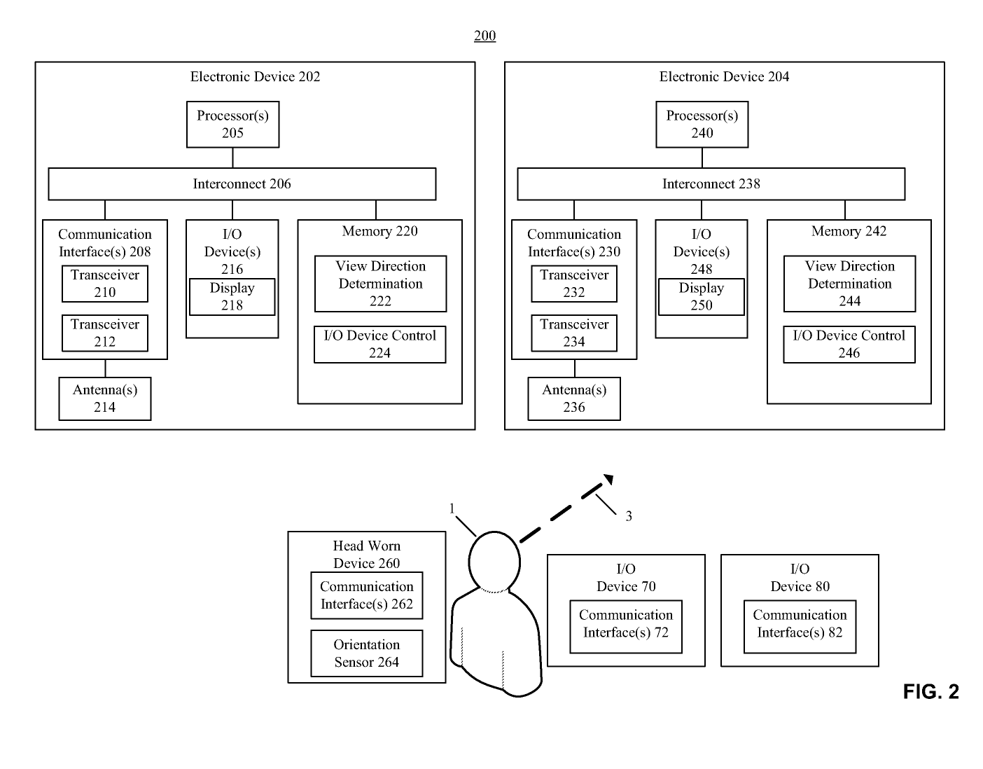

FIG. 2 illustrates a system 200 for operating an input/output device in a further example. System 200 includes an electronic device 202, an electronic device 204, and a head worn device 260. Head worn device 260 includes communication interface(s) 262 and one or more orientation sensors 264. Head worn device 260 may, for example, be a headset, headphones, or eye glasses. Orientation sensors 264 may utilize an electronic compass (magnetometer) supported by an accelerometer for eliminating tilt sensitivity, or a gyroscope, or all three in a sensor fusion system to detect a viewing direction 3 of user 1. Unless described otherwise, components and applications of electronic device 202 having the same name as electronic device 2 described above are substantially similar and operate in substantially the same way and are not repeated. System 200 also includes an input/output (I/O) device 70, and an I/O device 80 as described above with respect to FIG. 1. Electronic device 202 and electronic device 204 may, for example, be a laptop computer, tablet computer, smart phone, or desktop computer.

Electronic device 202 includes input/output (I/O) device(s) 216 configured to interface with the user, including a display 218. I/O device(s) 216 may also include additional input devices, such as a touch screen, etc., and additional output devices. Display 218 may, for example, be a liquid crystal display (LCD).

The electronic device 202 includes a processor 205 configured to execute code stored in a memory 220. Processor 205 executes a view direction determination application 222 and an I/O device control application 224 to perform functions described herein. Although shown as separate applications, view direction determination application 222 and I/O device control application 224 may be integrated into a single application.

Electronic device 202 includes communication interface(s) 208, one or more of which may utilize antenna(s) 214. The communications interface(s) 208 may also include other processing means, such as a digital signal processor and local oscillators. Communication interface(s) 208 include a transceiver 210 and a transceiver 212. Interconnect 206 may communicate information between the various components of electronic device 202.

In operation, view direction determination application 222 is configured to process the orientation data output from orientation sensor 264 to determine whether the user 1 is viewing the display 218. I/O device control application 224 is configured to operate the electronic device 202 with I/O device 70 and I/O device 80 if the user is viewing the display 218.

Electronic device 204 is similar to electronic device 202 and operates in substantially the same way as electronic device 202. Electronic device 204 includes input/output (I/O) device(s) 248 configured to interface with the user, including a display 250. I/O device(s) 248 may also include additional input devices, such as a touch screen, etc., and additional output devices. Display 250 may, for example, be a liquid crystal display (LCD).

The electronic device 204 includes a processor 240 configured to execute code stored in a memory 242. Processor 240 executes a view direction determination application 244 and an I/O device control application 246 to perform functions described herein. Although shown as separate applications, view direction determination application 244 and I/O device control application 246 may be integrated into a single application.

Electronic device 204 includes communication interface(s) 230, one or more of which may utilize antenna(s) 236. The communications interface(s) 230 may also include other processing means, such as a digital signal processor and local oscillators. Communication interface(s) 230 include a transceiver 232 and a transceiver 234. Interconnect 238 may communicate information between the various components of electronic device 204.

In operation, view direction determination application 244 is configured to process the orientation data output from orientation sensor 264 to determine whether the user 1 is viewing the display 250. I/O device control application 246 is configured to operate the electronic device 204 with I/O device 70 and I/O device 80 if the user is viewing the display 250.

In one example, a calibration process is utilized so that the orientation data from sensor 264 can be used to determine whether user 1 is viewing display 218 or display 250. During calibration, the user 1 views display 218 and the orientation sensor 264 output is monitored and stored for use by view direction determination application 222. The user 1 then views display 250 and the orientation sensor 264 output is monitored and stored for use by view direction determination application 244.

In the simplest embodiment, the user looks at a screen and hits a button or some other common user interface on either screen/device, or head-mounted device. If the head-mounted device has voice recognition capabilities, the user could say “calibrate”. At each calibrate point, a quaternion can be stored and a spread of angles about the current look angle/quaternion can be used to define the cone of angles that determine the user is looking at the screen/device. Additional calibrate points define additional screens. Calibration points can be removed using a user interface, or by gazing at the screen and saying “remove”. In another embodiment, each display screen available is assigned a number (e.g., 1, 2 or 3). The user calibrates the system by selecting one of the displays (through a user interface or voice command), looking at each of the four edges of the display while clicking a button on the computing device being calibrated (or head-mounted device if available) or issuing a voice command to “calibrate”. When done, the local electronic device would store the quaternions for each edge. The incoming quaternion stream is then used to compare to the edges and determine when the user is looking at the display. This may be done by reducing the incoming quaternions to Euler angles and verifying that the vertical and horizontal “look angles” match the range of the calibrated edges. All electronic devices are constantly examining the quaternion stream. When the user looks at a given display for an electronic device, the electronic device recognizes the user is looking at it.

In one usage scenario, user 1 faces either display 218 at electronic device 202 or display 250 at electronic device 204. The user viewing direction 3 is detected by electronic device 202 or electronic device 204 by processing orientation data output by orientation sensor 264 at head worn device 260. In one example, data output from orientation sensor 264 is sent to both electronic device 202 and electronic device 204 for processing by both devices. If electronic device 202 determines that the user 1 is viewing display 218, electronic device 202 is operated with I/O device 70 and I/O device 80. If electronic device 204 determines that the user 1 is viewing display 250, electronic device 204 is operated with I/O device 70 and I/O device 80.

Once either electronic device 202 or electronic device 204 determines user 1 is viewing either display 218 or display 250, respectively, electronic device 202 or electronic device 204 operate with I/O device 70 and I/O device 80 to transfer input/output data in a similar manner as described above in reference to FIG. 1.

In one example, to operate electronic device 202 with I/O device 70 and I/O device 80, a wireless link is activated or formed between electronic device 202 and I/O device 70 and I/O device 80, and input/output data is transferred to and from electronic device 202.

In a further embodiment, data is transferred from I/O device 70 and I/O device 80 to both electronic device 202 and electronic device 204 regardless of whether the user 1 is viewing display 218 or display 250. In this embodiment, if electronic device 202 determines that the user 1 is viewing display 218, to operate electronic device 202 with I/O device 70 and I/O device 80, electronic device 202 acts upon the received input/output data (i.e., as opposed to merely receiving the data and not acting upon the data). Similarly, if electronic device 204 determines that the user 1 is viewing display 250, to operate electronic device 204 with I/O device 70 and I/O device 80, electronic device 204 acts upon the received input/output data (i.e., as opposed to merely receiving the data and not acting upon the data).

In one embodiment, electronic device 202, electronic device 204, I/O device 70, and I/O device 80 include Bluetooth communication modules for Bluetooth wireless communications. One or more Bluetooth piconets may be utilized to connect the devices. For example, a point-to-multipoint connection is utilized to connect electronic device 202 to I/O device 70 and I/O device 80. Similarly, a point-to-point multipoint connection is utilized to connect electronic device 204 to I/O device 70 and I/O device 80.

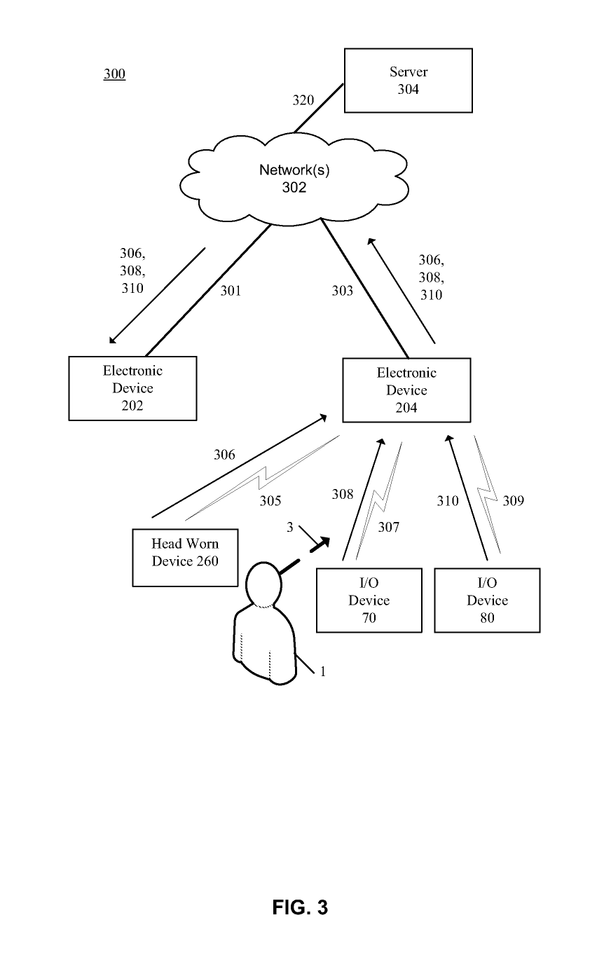

FIG. 3 illustrates an example implementation 300 of the system shown in FIG. 2. FIG. 3 illustrates the flow of device input/output data and data output from orientation sensor 264 in one example. Referring to FIG. 2 and FIG. 3, in implementation 300, electronic device 202 and electronic device 204 are connected to network(s) 302. Electronic device 202 is capable of communications with one or more communication network(s) 302 over network connection 301. Electronic device 204 is capable of communications with one or more communication network(s) 302 over network connection 303. A server 304 is capable of communications with one or more communication network(s) 302 over network connection 320. For example, communication network(s) 302 may include an Internet Protocol (IP) network, cellular communications network, public switched telephone network, IEEE 802.11 wireless network, or any combination thereof. Although shown as wired connections, network connection 301 and network connection 303 may be either wired or wireless network connections.

Head worn device 260 is capable of communications with electronic device 204 over a wireless link 305. I/O device 70 is capable of communications with electronic device 204 over a wireless link 307. I/O device 80 is capable of communications with electronic device 204 over a wireless link 309.

In operation, sensor output 306 from orientation sensor 264 is sent to electronic device 204 from head worn device 260. I/O data 308 is sent to electronic device 204 from I/O device 70. I/O data 310 is sent to electronic device 204 from I/O device 80. Sensor output 306, I/O data 308, and I/O data 310 are then sent to server 304, which sends them to electronic device 202 via network(s) 302. Where there are additional electronic devices having displays (not shown in this implementation 300), server 304 also sends sensor output 306, I/O data 308, and I/O data 310 to these devices. In a further example, server 304 also sends sensor output 306, I/O data 308, and I/O data 310 to electronic device 204.

Sensor output 306, I/O data 308, and I/O data 310 are utilized at electronic device 202 by view direction determination application 224 and I/O device control application 224 as described above. Sensor output 306, I/O data 308, and I/O data 310 are utilized at electronic device 204 by view direction determination application 244 and I/O device control application 246 as described above. In a further embodiment, sensor output 306, I/O data 308, and I/O data 310 are sent from electronic device 204 to electronic device 202 directly or via network(s) 302 without the use of a server 304.

In one implementation, a service executing on electronic device 204 collects events (e.g., sensor output 306, I/O data 308, and I/O data 310) and passes them on to server 304. The events are translated into a machine independent format. For example, I/O data 308 may be mouse events. Mouse events contain change in mouse X/Y position from a last sent value. This can be done in standard user interface independent units. I/O data 310 may be keyboard events. Keyboard events contain which key was pressed, including whether it was a press, release or hold, etc. This can be described in PC independent fashion.

Head tracking events (e.g. sensor output 306) contain the current angles or quaternion for the head worn device 260. These can be converted into a heading, either absolute (e.g., 30° NE) or relative to some calibration. They can also be converted into an elevation (e.g., 30 degrees up or down) if the sensors provide the additional tilt information. Using the calibration process described herein, sensor output 306 can be translated into a YES/NO whether the user 1 is looking at a display.

Server 304 can be a server on the local network, or a virtual server in the cloud. An application in the cloud reviews head tracking events. Server 304 can process sensor output 306 to determine the user viewing direction. If user 1 is looking at a display 250 at electronic device 204, the events are sent back down to electronic device 204. If user 1 is looking at display 218 at electronic device 204, events are sent to electronic device 202.

In one implementation, server 304 operates as a relay, and any electronic device that subscribes to the server 304 can receive all mouse, keyboard, and head-tracking events. Then each electronic device can discriminate whether the user 1 is looking at its screen. In one example, a service running on electronic device 202 and electronic device 204 receives the events and converts them into actual mouse movements or keyboard presses from the device independent format.

The user 1 may calibrate the location of the device screens using either absolute or relative position. For example, the user 1 can describe his screen in absolute angles from where she sits at the screen. For example, a screen may be 30° NE to 60° NE. Head elevation is −15 degrees down to +15 degrees up. This can be updated when the user 1 moves the screen. To calibrate using relative position, the user 1 hits a button or key to indicate when she is looking at the left, right, top, bottom edges of the screen to be calibrated. These are translated by a program on the electronic device into quaternions which are then sent to the server 304. The user 1 can update whenever they wish if they move their screen. The quaternions are easily compared with the actual current existing quaternion to validate the angle is within the range of the screen. The screen location is sent to the server 304 typically one time, but the user 1 can update if desired. If electronic device 202 and electronic device 204 are doing the discrimination, then they store the calibration data, not the server 304.

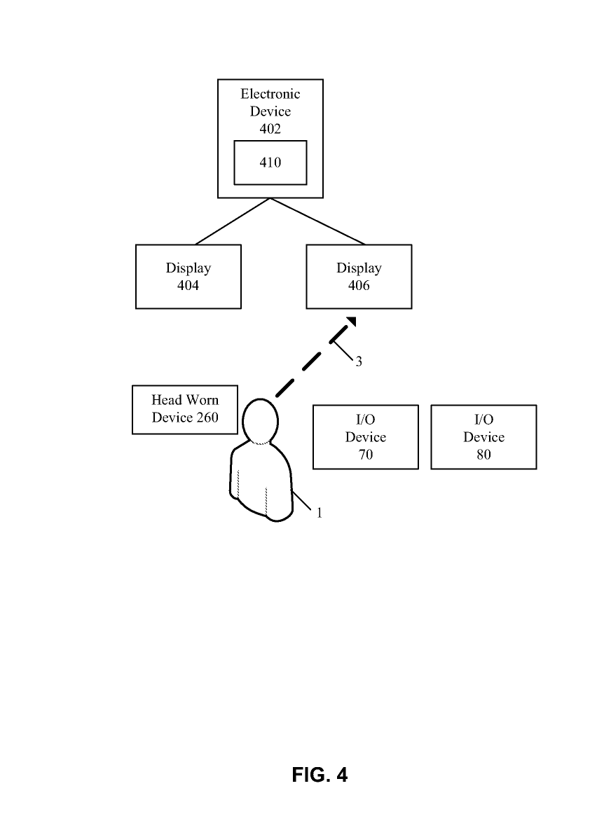

FIG. 4 illustrates a system for operating an input/output device in a further example. In the example shown in FIG. 4, an electronic device 402 includes a display 404 and a display 406. Electronic device 402 executes a view direction determination application 410. A user 1 having a head worn device 260 utilizes I/O device 70 and I/O device 80 with electronic device 402. For example, a wireless connection exists between I/O device 70 and electronic device 402 and a wireless connection exists between I/O device 80 and electronic device 402.

In operation, view direction determination application 410 receives an output from the orientation sensor at head worn device 260 and processes the sensor output to determine whether the user is viewing display 404 or display 406. In a further example where both display 404 and display 406 each have a camera, view direction determination application 410 processes the camera outputs to determine whether the user is viewing display 404 or display 406. In one example usage scenario, the view direction determination application 410 is configured to operate the input/output devices 70, 80 with a first application shown on the display 404 if the user 1 is viewing the display 404 or operate the input/output devices 70, 80 with a second application shown on the second display 406 if the user 1 is viewing the second display 406. In one usage scenario, data from the I/O devices 70, 80 are sent only to the active applications running on the display being viewed. In a further example, each display is subdivided into multiple regions and it is determined which region the user is viewing. A cursor on a display may be moved responsive to the user gaze. Audio may be controlled based on the user gaze direction as well as keyboard entry.

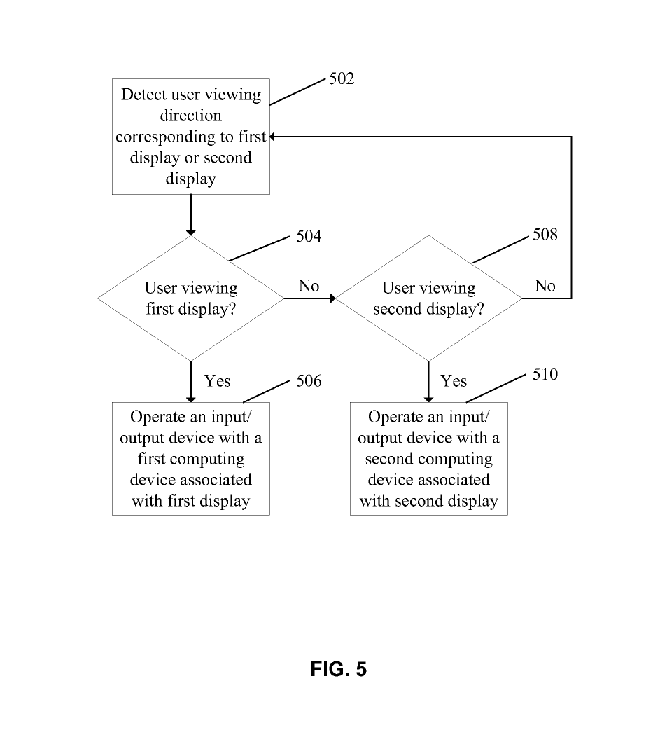

FIG. 5 is a flow diagram illustrating operation of an input/output device in one example. At block 502, a user viewing direction corresponding to a first display associated with a first computing device or a second display associated with a second computing device is detected. In one example, the first display or second display is a display device or an image projected onto a surface. In one example, detecting a user viewing direction includes processing a data output from a camera. In a further example, detecting a user viewing direction includes processing a data output from an orientation sensor disposed at a head worn device.

At decision block 504, it is determined whether the user is viewing the first display. If yes at decision block 504, at block 506 an input/output device is operated with a first computing device associated with the first display. In one example, the input/output device is a wireless keyboard, a wireless mouse, or a wireless head worn device.

If no at decision block 504, at decision block 508 it is determined if the user is viewing the second display. If no at decision block 508, the process returns to block 502. If yes at decision block 508, at block 510 the input/output device is operated with a second computing device associated with the second display.

In one example, operating an input/output device with the first computing device or the second computing device involves performing an input or output operation or transferring data to or from the input/output device. In one example, operating an input/output device with the first computing device or the second computing device includes transferring data utilizing wireless communications. In one example, the input/output device is wirelessly paired with the first computing device and the second computing device for wireless communications utilizing the Bluetooth protocol.

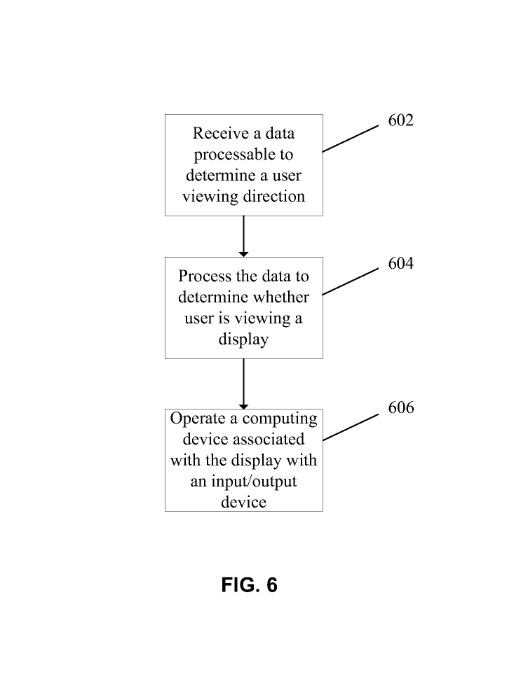

FIG. 6 is a flow diagram illustrating operation of an input/output device in one example. At block 602, a data processable to determine a user viewing direction is received. In one example, the data processable to determine a user viewing direction is received from a server. In one example, the data includes a camera output data or an orientation sensor output data.

At block 604, the received data is processed to determine whether the user is viewing a display. At block 606, responsive to a determination the user is viewing the display, a computing device associated with the display is operated with an input/output device. In one example, operating a computing device associated with the display with an input/output device includes activating a wireless link between the computing device and the input/output device and transferring input/output data. In one example, the input/output device is a wireless keyboard, a wireless mouse, or a wireless head worn device.

In a further example, an input/output data is received from the input/output device, where operating a computing device associated with the display with an input/output device includes acting upon the input/output data. In one example, the input/output data is received from a server.

While the exemplary embodiments of the present invention are described and illustrated herein, it will be appreciated that they are merely illustrative and that modifications can be made to these embodiments without departing from the spirit and scope of the invention. For example, methods, techniques, and apparatuses described as applying to one embodiment or example may also be utilized with other embodiments or examples described herein. Thus, the scope of the invention is intended to be defined only in terms of the following claims as may be amended, with each claim being expressly incorporated into this Description of Specific Embodiments as an embodiment of the invention.

What is claimed is:

1. A method for operating a peripheral device comprising:
detecting a user viewing direction corresponding to a first display associated with a first device or a second display associated with a second device; and
responsive to the user viewing direction, operating a peripheral device with the first device or the second device.

2. The method of claim 1, wherein detecting a user viewing direction comprises processing a data output from a camera.

3. The method of claim 1, wherein detecting a user viewing direction comprises processing a data output from an orientation sensor disposed at a head worn device.

4. The method of claim 1, wherein operating a peripheral device with the first device or the second device comprises performing an input or output operation or transferring data to or from the peripheral device.

5. The method of claim 1, wherein the peripheral device is a wireless keyboard, a wireless mouse, or a wireless head worn device.

6. The method of claim 1, wherein operating a peripheral device with the first device or the second device comprises transferring data utilizing wireless communications.

7. The method of claim 1, wherein the peripheral device is wirelessly paired with the first device and the second device for wireless communications utilizing a Bluetooth communications protocol.

8. The method of claim 1, wherein the first display or second display is a display device or an image projected onto a surface.

9. A non-transitory computer readable storage memory storing instructions that when executed by a computer cause the computer to perform a method for operating a device comprising:
receiving a data processable to determine a user viewing direction;
processing the data to determine whether the user is viewing a display; and
responsive to a determination the user is viewing the display, operating a device associated with the display with an input/output device.

10. The non-transitory computer readable storage memory of claim 9, the method further comprising receiving an input/output data from the input/output device, wherein operating a device associated with the display with an input/output device comprises acting upon the input/output data.

11. The non-transitory computer readable storage memory of claim 10, wherein the input/output data is received from a server.

12. The non-transitory computer readable storage memory of claim 9, wherein operating a device associated with the display with an input/output device comprises activating a wireless link between the device and the input/output device and transferring input/output data.

13. The non-transitory computer readable storage memory of claim 9, wherein the data processable to determine a user viewing direction is received from a server.

14. The non-transitory computer readable storage memory of claim 9, wherein the data comprises a camera output data.

15. The non-transitory computer readable storage memory of claim 9, wherein the data comprises an orientation sensor output data.

16. The non-transitory computer readable storage memory of claim 9, wherein the input/output device is a wireless keyboard, a wireless mouse, or a wireless head worn device.

17. A device comprising:
a processor;
a wireless transceiver operable to form a wireless communications link with an input/output device;
a display; and
a memory storing an application executable by the processor, the application configured to process a data to determine whether a user is viewing the display, wherein the application is further configured to operate the device with the input/output device if the user is viewing the display.

18. The device of claim 17, further comprising a camera, wherein the data processed to determine whether the user is viewing the display is an output from the camera.

19. The device of claim 17, wherein the data processed to determine whether the user is viewing the display is an output associated with a sensor disposed at a head worn device.

20. The device of claim 19, wherein the head worn device is a headset, headphones, or eye glasses.

21. The device of claim 19, wherein the sensor comprises a compass and outputs orientation data.

22. The device of claim 17, further comprising a second display, wherein the application is further configured to determine whether the user is viewing the display or the second display.

23. The device of claim 22, wherein a first application window is shown on the display and a second application window is shown on the second display, wherein the first application window is active and interfaces with the input/output device if the user is viewing the display and the second application window is active and interfaces with the input/output device if the user is viewing the second display.

24. The device of claim 17, wherein to operate the device with the input/output device, an input/output data is acted upon or received and acted upon.
